(19) United States
(12) Patent Application Publication
(10) Pub. No.: US 2010/0206614 A1
(43) Pub. Date: Aug. 19, 2010

(54) ELECTRONIC FABRIC AND PREPARING THEREOF

(76) Inventors: Sung Mee Park, Atlanta, GA (US); Kwang Su Cho, Yongin-si (KR); Kyung Hee Chung, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 12/738,565

(22) PCT Filed: Oct. 16, 2008
(86) PCT No.: PCT/KR08/06101

§ 371 Date: Apr. 16, 2010

(30) Foreign Application Priority Data
Oct. 16, 2007 (KR) 10-2007-0104205

(51) Int. Cl. H01B 5/00; B05D 5/12; B32B 3/00

(52) U.S. Cl. 174/126.1; 427/97.3; 428/141

(57) ABSTRACT

Disclosed herein is an electronic fabric and preparing thereof. The electronic fabric comprises a backing layer configured to have a circuit electrically floated and a surface layer configured to electrically connect to the circuit of the backing layer. The backing layer or the surface layer comprises a) a base layer composed of a synthetic, regenerated or natural fiber and b) a conductive layer formed on the base layer to be capable of being freely formed by a pre-designed electric pattern. The base layer and the conductive layer are successively formed to be symmetrically to the backing layer and the surface layer to each other. An insulating layer is formed on the backing layer or the surface layer, or a partial upper portion of the conductive layer, or in a region where the conductive layer is not formed.

### TECHNICAL FIELD

The present invention relates to an electronic fabric and preparing thereof, and more particularly to an electronic fabric capable of generating an electronic signal, transmitting the electronic signal, and processing and displaying the transmitted electronic signal without any restriction to dynamic wearability.

### BACKGROUND ART

Smart clothes result from bonding high technology and clothe are derived from body-mounted wearable computers by separating computer apparatus in 1960s. Wearable computers are defined as computers that are subsumed or integrated into the personal space of a user and controlled by the user and are a constant interaction between the computers and user. For example, wearable computers can be operated in any time because power supply is always turned on and considered as computers combined with clothes. Recently, the concept of smart clothes has been changed and defined as brand new cloth having life convenience as well as providing high added value by employing IT functions to clothes.

In other words, smart clothes can be simply defined as new kinds of clothes incorporating various digital devices and function required in future usual life into clothes. Smart materials for these smart clothes are termed “E-textile” since they have the electric characteristic unlike materials used as clothes.

Extensive studies about high-performance textiles have been made in smart clothes. These textiles such as conductive textile materials, fabric signal line, fabric input devices, optical fibers, bio-protection fabric and so forth, perform a function to maintain transmit digital signals while producing a tactile feeling and physical properties identical to general textiles.

In recent years, various products have been introduced such as clothes with functional clothes incorporating Mp3 players, healthcare, heating system, optical-fiber, digital color clothes, underwear for preventing missing children, etc.

Accordingly, smart wear is required to meet activity and endurance. That is, fabrics serving as basic materials of smart wear require the following dynamic wearing characteristics. The physical requirements for wearers and devices include placement of the devices, form language of the devices, human movement, human perception of an intimate space, size variation, and attachment of the devices.

Further, in view of the relationship between wearers and ambient atmospheres, containment of the devices, weight of the devices, accessibility, sensory interaction, thermal comfort, aesthetics, long-term effects, etc. are considered [Gemperle, F.; Kasabach, C.; Stivoric, J.; Bauer, M.; Martin, R.; (1998) “Design for Wearability”, Digest of Papers, 2nd International Symposium of Wearable Computer, IEEE Computer Society].

In view of above, it is difficult to design the proposed electrically conductive textiles for smart clothes so as to correspond to the placement and form of electronic devices. In other words, no alternative can be provided in view of the physical requirements for wearers and devices. Furthermore, the proposed fabrics suffer from great limitations in fiber volume, washing characteristics, etc. from the viewpoint of the maintenance of the inherent nature of the fibers.

Such a technique combining apparatus capable of creating electric signals and fabrics is disclosed in U.S. Pat. No. 7,176,895. In this patent, the keyboard apparatus is materialized on fabrics. Such a keyboard is formed by a capsule containing an electrically responsive liquid.

One problem with this type of keyboard is flexibility and coatability. The other problem is that the keyboard is formed by the capsule so that it is broken during washing or under severe operation condition. As a result, the keyboard is not operated normally.

### DISCLOSURE

### Technical Problem

The present invention has been made in an effort to solve the above problems, and it is one object of the present invention to provide an electric fabric capable of generating an electric signal and transmitting the generated signal without any restriction to dynamic wearability, and a method for fabricating the electric fabric.

It is another object of the present invention is to provide an electric fabric in which a circuit can be freely designed regardless of the form or placement of an electronic device, and a method for fabricating the electric fabric.

It is another object of the present invention is to provide an electric fabric that is free from any defect or circuit failure by circuit disconnection, and a method for fabricating the electric fabric.

It is another object of the present invention is to provide an electric fabric that exhibits satisfactory electrical properties without deteriorating the intrinsic physical properties of a textile usable as a material for clothing, and a method for fabricating the electric fabric.

It is still another object of the present invention is to provide a washable electric fabric and a method for fabricating the electric fabric.

### Technical Solution

Embodiments of the present invention provide an electric fabric comprising a backing layer having a circuit electrically floated and a surface layer electrically connected to the circuit of the backing layer, wherein the backing layer or the surface layer comprises a) a base layer composed of a synthetic, regenerated or natural fiber and b) a conductive layer formed on the base layer to be capable of being freely formed by a pre-designed electric pattern, wherein the base layer and the conductive layer are successively formed to be symmetrically to the backing layer and the surface layer each other, and wherein an insulating layer is formed on the backing layer or the surface layer, or a partial upper portion of the conductive layer, or a region where the conductive layer is not formed.

In some embodiments of the present invention, the electronic fabric further comprises a pad layer on an upper portion of the surface layer.

In other embodiments of the present invention, a printing layer is further formed an upper portion of the surface layer or the pad layer and formed at a region where the insulating layer is not formed.

In further embodiments of the present invention, the upper portion (an opposite side of interfaces between the surface layer and the backing layer) of the surface layer has an uneven surface topology.

In other embodiments of the present invention, the upper portion (an opposite side of interfaces between the surface layer and the pad layer) of the pad layer has an uneven surface topology.

In yet other embodiments of the present invention, the insulating layer is formed in a region corresponding to a concave portion of the uneven surface topology.

In further embodiments of the present invention, a filling member is further included between the pad layer and the surface layer.

In other embodiments of the present invention, the filling member is formed in a region where the insulating layer is not formed.

In further embodiments of the present invention, the electronic fabric further comprises a primer layer formed on the base layer to make the surface of the base layer uniform.

In yet further embodiments of the present invention, the primer layer is formed of at least one resin selected from the group consisting of polyurethane-based, acrylic-based and silicone-based resins.

In other embodiments of the present invention, the conductive layer is formed of a conductive material or a mixture thereof with a binder.

In yet other embodiments of the present invention, the conductive material is formed of at least one selected from the group consisting of conductive polymer, carbon, silver, gold, platinum, palladium, copper, aluminum, tartar, iron, and nickel.

In further embodiments of the present invention, the conductive polymer is at least one selected from the group consisting of polyaniline, polypyrrole, polythiophene, and mixtures thereof.

In other embodiments of the present invention, the binder is at least one selected from the group consisting of polyurethane-based resins, acrylic-based resins, silicone-based resins, melamine-based resins, and epoxy-based resins.

In further embodiments of the present invention, the conductive layer has a thickness of 2 mm to 500 mm.

In yet further embodiments of the present invention, the insulating layer is formed by coating, printing, laminating, or bonding at least one selected from the group consisting of polyurethane, acrylic, silicon, polyester, polyvinyl chloride (PVC) and polytetrafluoroethylene (PTFE)-based resins on the conductive layer

Embodiments of the present invention provides a method for fabricating an electronic fabric comprising: forming a backing layer having a circuit electrically floated; forming a surface layer electrically connected to the circuit of the backing layer; and integrating the backing layer and the surface layer, wherein the backing layer or the surface layer comprises: a) forming a base layer composed of a synthetic, regenerated or natural fiber; b) forming a conductive layer formed on the base layer to be capable of being freely formed by a pre-designed electric pattern; and c) forming an insulating layer is formed on the backing layer or the surface layer, or a partial upper portion of the conductive layer, or a region where the conductive layer is not formed.

In some embodiments of the present invention, the method further comprises forming a pad layer on an upper portion of the surface layer before integrating the backing layer and the surface layer.

In other some embodiments of the present invention, the method further comprises a printing layer on an upper portion of the surface layer or the pad layer. The printing layer is formed at a region where the insulating layer is not formed.

In further embodiments of the present invention, the upper portion (an opposite side of interfaces between the surface layer and the backing layer) of the surface layer has an uneven surface topology.

In other embodiments of the present invention, the upper portion (an opposite side of interfaces between the surface layer and the pad layer) of the pad layer has an uneven surface topology.

In yet other embodiments of the present invention, the insulating layer is formed in a region corresponding to a concave portion of the uneven surface topology.

In further embodiments of the present invention, a filling member is further included between the pad layer and the surface layer.

In other embodiments of the present invention, the filling member is formed in a region where the insulating layer is not formed.

In further embodiments of the present invention, the method further comprises forming a primer layer formed on the base layer to make the surface of the base layer uniform.

In yet further embodiments of the present invention, the method further comprises calendering the base layer using a pressing roller before the formation of the primer layer to offset pores of the base layer and enhance the flex resistance.

In other embodiments of the present invention, the primer layer is formed by knife rolling, over roll coating, floating knife coating, or knife over roll coating, laminating, printing, or gravure printing.

In yet other embodiments of the present invention, the primer layer is formed of at least one resin selected from the group consisting of polyurethane-based, acrylic-based and silicone-based resins.

In further embodiments of the present invention, the conductive layer are coated by at least one selected from the group consisting of coating, printing, and transfer-style printing.

In other embodiments of the present invention, the conductive layer is formed of a conductive material or a mixture thereof with a binder.

In further embodiments of the present invention, the conductive material is formed of at least one selected from the group consisting of conductive polymer, carbon, silver, gold, platinum, palladium, copper, aluminum, tartar, iron, and nickel.

In yet further embodiments of the present invention, the binder is at least one selected from the group consisting of polyurethane-based resins, acrylic-based resins, silicone-based resins, melamine-based resins, and epoxy-based resins.

In other embodiments of the present invention, the conductive polymer is at least one selected from the group consisting of polyaniline, polypyrrole, polythiophene, and mixtures thereof.

In yet other embodiments of the present invention, the conductive layer has a thickness of 2 mm to 500 mm.

In further embodiments of the present invention, the insulating layer is formed by coating, printing, laminating, or bonding at least one selected from the group consisting of polyurethane, acrylic, silicon, polyester, poly-vinyl chloride (PVC) and polytetrafluoroethylene (PTFE)-based resins on the conductive layer.

In other embodiments of the present invention, the insulating layer is formed by drying in case of direct coating, or hot-melt dot or gravure printing in case of laminating.

Embodiments of the present invention provides an electronic fabric having multi-layered layers, wherein insulating materials are coated in any one layer or corresponding regions with each other. The conductive materials are exposed at one or more regions that are not coated with the insulating materials in the electronic fabric. One or more of conductive materials are exposed at a region not coated with insulating materials. An opposite side of the region where conductive materials are exposed has an uneven surface topology to dispose a printing layer or a protrusion portion thereon. The region coated with conductive materials is not contact with the insulating materials, and if the printing layer or the protrusion portion is sensed, the conductive materials are contact with each other to generate an electronic signal.

### ADVANTAGEOUS EFFECTS

According to the electronic fabric and the preparing thereof, an electronic fabric in which a pattern can be freely formed without any restriction to ensure dynamic wearability as well as to generate an electronic signal and embedding recognition function is provided. Further, according to the electronic fabric and the preparing thereof, a circuit can be designed regardless of bending or folding due to the elasticity, flex resistance, and flexibility of a fiber as a material for a base layer to substantially prevent the circuit from damage, such as disconnection.

Further, the electronic fabric and the preparing thereof perform a function to generate an electronic signal while retaining inherent functions (e.g., coatability, comfort, breathable waterproofness and tensile strength) of fabric (i.e. clothing).

Further, according to the electronic fabric and the preparing thereof, a conductive layer can be maintained in a uniform due to the presence of a primer layer to allow a constant electric current to flow therethrough.

Further, according to the electronic fabric and the preparing thereof, bent portions of a circuit are formed in a circular or oval shape by printing a pattern on a heating layer and/or a conductive layer, so that sectional area is enlarged to smoothly allow electric current to smoothly flow therethrough.

Further, according to the electronic fabric and the preparing thereof, an insulating layer is made of a material compatible with a conductive layer to improve tensile strength and elongation.

Further, the electronic fabric has washing fastness by coating an insulating layer at one surface or both surfaces thereof.

Further, according to the electronic fabric and the preparing thereof, an uneven surface structure of keyboard-shaped is provided on a surface of fabrics. If pressure is imposed to the uneven surface structure, various functions can be performed. Additionally, such a pressure is imposed to the conductive layer, thereby easily performing commands.

Further, according to the electronic fabric and the preparing thereof, an uneven surface structure of keyboard-shaped is additionally formed on a surface of fabrics. As a result, it is possible to replace the surface of fabrics having various materials and shapes.

### DESCRIPTION OF DRAWINGS

FIG. 1 is a cross-sectional view of a conventional keyboard apparatus.

FIGS. 2 and 3 are cross-sectional views of a double-layered fabric according to an embodiment of the present invention.

FIG. 4 is a cross-sectional view of a double-layered fabric according to another embodiment of the present invention.

FIGS. 5 to 7 are cross-sectional views of a double-layered fabric according to another embodiment of the present invention.

FIGS. 8 to 10 are cross-sectional views of a double-layered fabric having a printing layer according to another embodiment of the present invention.

FIGS. 11 to 13 are cross-sectional views of a double-layered fabric having uneven surface topology according to another embodiment of the present invention.

FIGS. 14 and 15 are cross-sectional views of a triple-layered fabric according to another embodiment of the present invention.

FIG. 16 is a cross-sectional view of a double-layered fabric according to another embodiment of the present invention.

FIG. 17 is a process flowchart for illustrating a method for preparing a double-layered electronic fabric according to a preferred embodiment of the present invention.

FIG. 18 is a process flowchart for illustrating a method for preparing a triple-layered electronic fabric according to a preferred embodiment of the present invention.

FIG. 19 is a process flowchart for illustrating a method for forming a backing layer of an electronic fabric according to a preferred embodiment of the present invention.

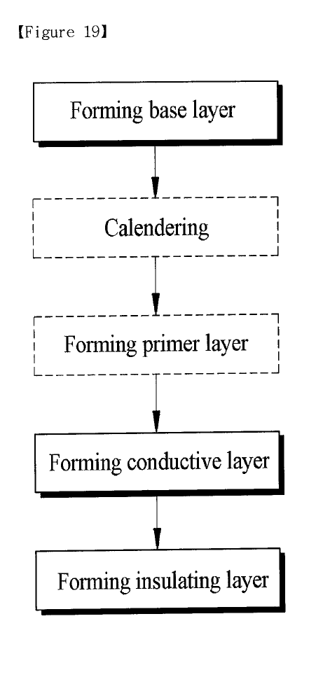

FIG. 20 shows an exemplary application of an electronic fabric according to the present invention.

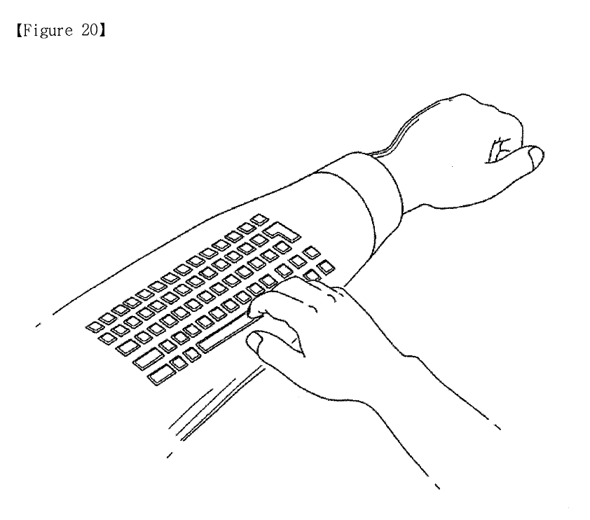

### BRIEF EXPLANATION OF ESSENTIAL PARTS OF THE DRAWINGS

| | |
|---|---|
| 100: Backing layer, | 200: Surface layer, |
| 110, 210: Base layer, | 120, 220: Primer layer |
| 130, 230: Conductive layer, | 140, 240: Insulating layer |
| 250, 310: Printing layer, | 400: Filling Member |
| 211, 311: Protrusion portion, | 213, 313: Concave portion |

### Best Mode

Preferred embodiments of the present invention will now be described in detail with reference to the accompanying drawings. It should be noted that whenever possible, the same reference numerals will be used throughout the drawings and the description to refer to the same or like parts. In describing the present invention, detailed descriptions of related known functions or configurations are omitted in order to avoid making the essential subject of the invention unclear.

As used herein, the terms “about”, “substantially” etc. are intended to allow some leeway in mathematical exactness to account for tolerances that are acceptable in the trade and to prevent any unconscientious violator from unduly taking advantage of the disclosure in which exact or absolute numerical values are given so as to help understand the invention.

As utilized herein, the term “fabric”⊚is intended to include articles produced by weaving or knitting, non-woven fabrics, fiber webs, and so forth.

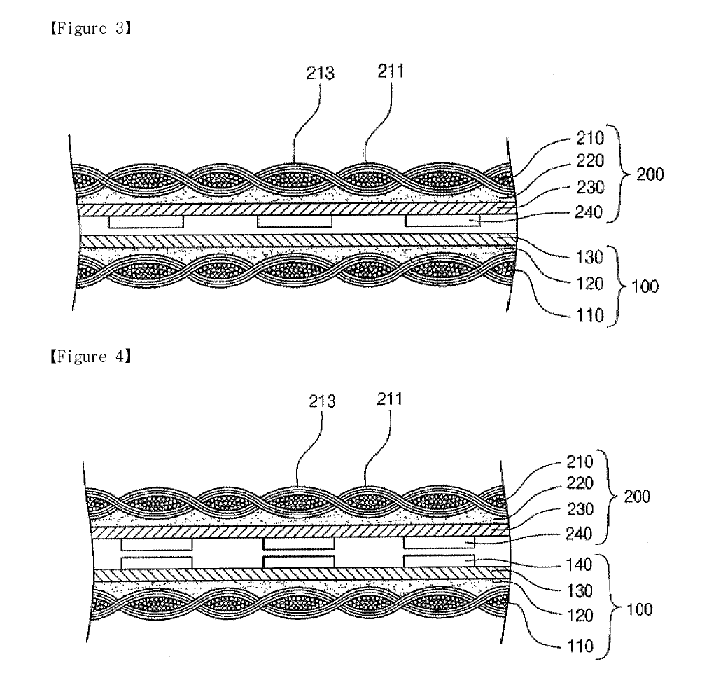

FIGS. 2 and 3 are cross-sectional views of a double-layered fabric according to an embodiment of the present invention.

With reference to FIGS. 2 and 3, an electronic fabric according to the present invention may be formed in a double-layered structure comprising a backing layer 100 and a surface layer 200.

The backing layer 100 comprises a base layer 110, a primer layer 120, a conductive layer 130, and an insulating layer 140. Optionally, the insulating layer 140 may be omitted. The surface layer 200 comprises a base layer 210, a primer layer 220, a conductive layer, and an insulating layer 240. Optionally, the insulating layer 240 may be omitted.

In advance, the structure of the backing layer 100 will be described. Any type of woven or knitted fabric, non-woven fabric, fiber web or so forth may be used to form the base layer 100. There is no particular limitation on the material and formation method of the base layer. For example, the base layer 100 may be composed of a synthetic fiber (e.g., polyester, polyamide or polyurethane), a cellulose regenerated fiber (e.g., rayon or acetate) or a natural fiber (e.g., cotton or wool).

The base layer 110 has a very non-uniform microscopic surface and extremely many fine pores due to gaps between fiber filaments. The primer layer 120 formed on the base layer 110 makes the surface of the base layer 110 uniform and allows the conductive layer to be formed to a uniform thickness. The primer layer 120 prevents a constituent material of the conductive layer from penetrating the base layer 110. The primer layer 120 may be formed of at least one resin selected from the group consisting of polyurethane, acrylic and silicone resins. Thus, it is to be understood that the primer layer 200 can be excluded according to the characteristics of fabric.

Electricity can flow through the conductive layer 130 formed on the primer layer 120. The shape of the conductive layer 130 can be pre-designed. The conductive layer 130 may be formed of at least one selected from the group consisting of conductive polymer, carbon, metal material such as silver, and a mixture thereof with a binder. For example, the conductive layer 130 is formed of a dispersion of an electrically-conductive filler in a vehicle, which is printed to form an electrically conductive cured film. Typical applications of the conductive layer 130 are LCD electrode printing, touch screen printing, conductive pattern printing for circuit boards, contact and pattern printing of thin-film switch plates and electromagnetic shielding. Non-limiting examples of suitable conductive fillers for use in the present invention include conductive metals, such as silver, platinum, palladium, copper and nickel. Preferred is silver.

The conductive layer 130 preferably has a thickness of 2 mm to 500 mm. When the thickness of the conductive layer 130 is below the above-mentioned range, it is difficult to ensure the thickness uniformity of the conductive layer 400. Meanwhile, when the thickness of the conductive layer 130 is above the range, resistance becomes decreased, thereby leading to an increment in power consumption

The binder may be selected from the group consisting of polyurethane resins, acrylic resins, silicone resins, melamine resins, epoxy resins, and mixtures thereof.

The insulating layer 140 may be formed by coating, printing or laminating at least one resin selected from the group consisting of polyurethane, acrylic, silicone, polyester, polyvinyl chloride (PVC) and polytetrafluoroethylene (PTFE) resins on the conductive layer 130. The insulating layer 140 functions to protect the conductive layer from damage, such as cracks, impart flexibility to the fabric, and render the fabric breathable waterproof or waterproof. In addition, the insulating layer 140 prevents contact between the conductive layer of the backing layer 100 and the conductive layer of the surface layer 200.

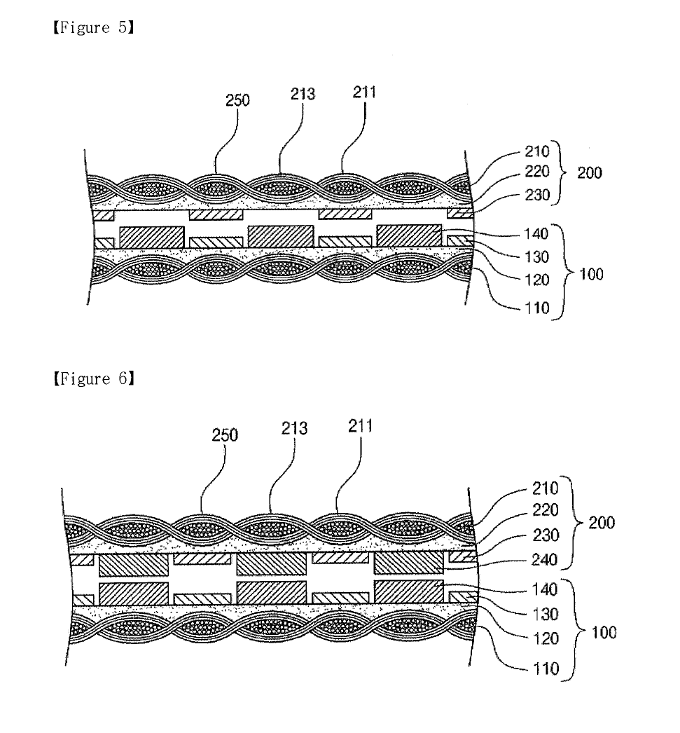

The insulating layer 140, as shown in FIG. 2, may be formed in only backing layer or may be formed in a location corresponding to the insulating layer 240 of the surface layer as shown in FIG. 4.

Meanwhile, the surface layer 200 may be formed on the backing layer 100. The surface layer 200 may be formed having the same material and thickness as the primer layer 220, the conductive layer 230, and the optional insulating layer 240 with the exception of the base layer 210.

The corresponding structure of the backing layer 100 and the surface layer 200 will be described in detail hereinafter. The backing layer 100 and the insulating layer 140 of the surface layer 200 may be formed at the same surface to correspond with each other as shown in FIG. 4 or may be formed at only surface layer 200 as shown in FIG. 3. In addition, the surface layer without the insulating layer and the conductive layers 130 and 230 of the surface layer may be formed at a corresponding location to contact at the same surface under the condition that the insulating layer is not formed.

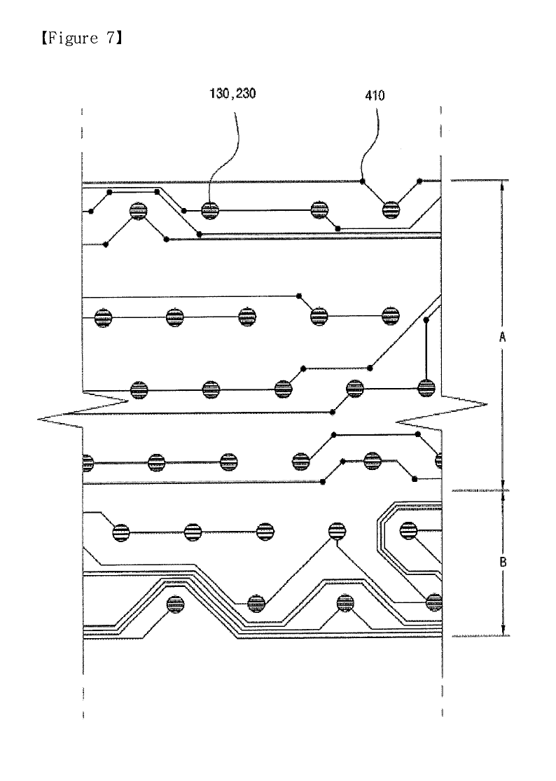

FIGS. 5 to 7 are cross-sectional views of a double-layered fabric according to another embodiment of the present invention and the basic structure thereof is the same as the embodiments shown in FIGS. 2 to 4. In the present embodiment, the conductive layer s130 and 230 are not formed on the insulating layers 140 and 240, but the conductive layer and the insulating layer may be formed on the base layers 110 and 220, or the primer layers 120 and 220 according to a pre-designed circuit (See FIG. 7).

Hereinafter, the principle for generating electronic signals will be described referring to a conventional keyboard apparatus.

Generally, a conventional keyboard is an input device like typewriters and is configured to include Korean alphabet, English alphabet, and special alphabet and several functional keys. Such a keyboard is not used independently but checks and transforms input data together with image display device (e.g., monitor).

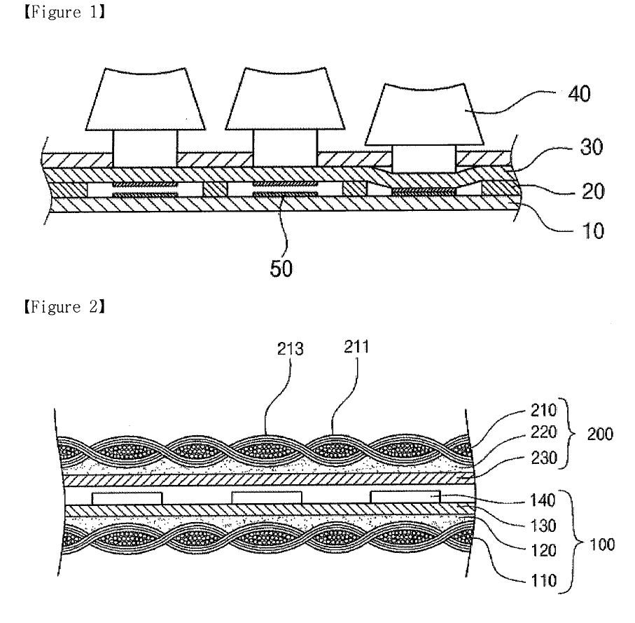

FIG. 1 is a cross-sectional view of a conventional keyboard apparatus. The conventional keyboard apparatus comprises a recognition key 40, an upper and lower printing circuit substrates 10 and 30, and a spacer. A predetermined number or sign is shown in the recognition key 40. The upper and lower printing circuit substrates 10 and 30 are operated by the pressure of the recognition key 40. The space 20 maintains pores of the printing circuit substrates. Normally, the upper and lower printing circuit substrates 10 and 30 are not in contact with each other by the space 20. In the event that pressure is imposed to the recognition key 40, the upper and lower printing circuit substrates 10 and 30 are in contact to be electrically connected so as to recognize electronic signals.

The electronic fabric according to the present invention does not employ additional means such as the spacer. Gaps between circuits is maintained by the insulating layers 140 and 240 normally. If pressure is imposed to the base layer 210 or a printing layer or a protrusion portion is sensed, a circuit is created by contacting the conductive layer 130 of the backing layer and the conductive layer 230 of the surface layer, thereby generating electronic signals. Accordingly, there should not be formed any insulating layer in a lower structure of the protrusion portion of the base layer and in the surface layer in a region corresponding to the lower structure of the protrusion portion. In this regards, “sensing”⊚means various operations for generating electronic signals such as pressurizing, contacting, and temperature variation but is not limited.

The backing layer 100 and surface layer 200 can be integrated by using various means such sewing, bonding, cross-linking via interlace yarns.

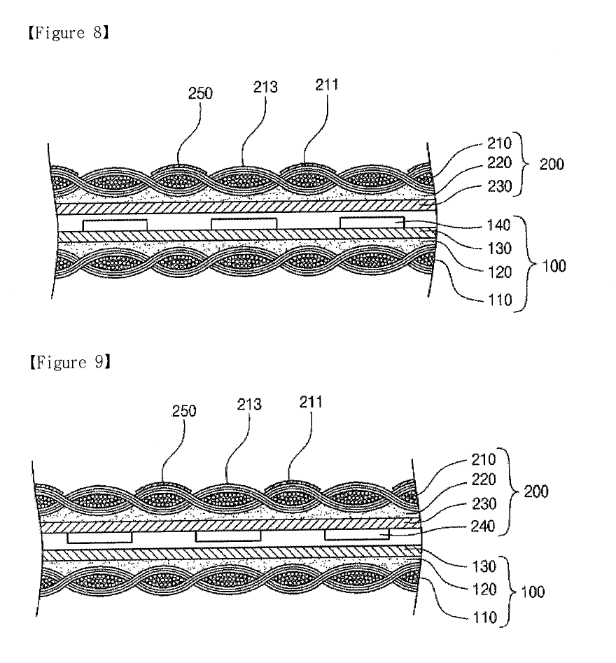

FIGS. 8 to 10 are cross-sectional views of a double-layered fabric having a printing layer according to another embodiment of the present invention.

With reference to FIGS. 8 to 10, a printing layer 250 is further formed on a surface of the surface layer 200, which can be considered as an upper portion of a region in which the insulating layers 140 and 240 are not formed. The surface may be formed in the same configuration as a button unit of keyboard apparatus as identified sign using weaving or knitting. Like the present embodiment, identified sign can be shown by forming additional printing layer.

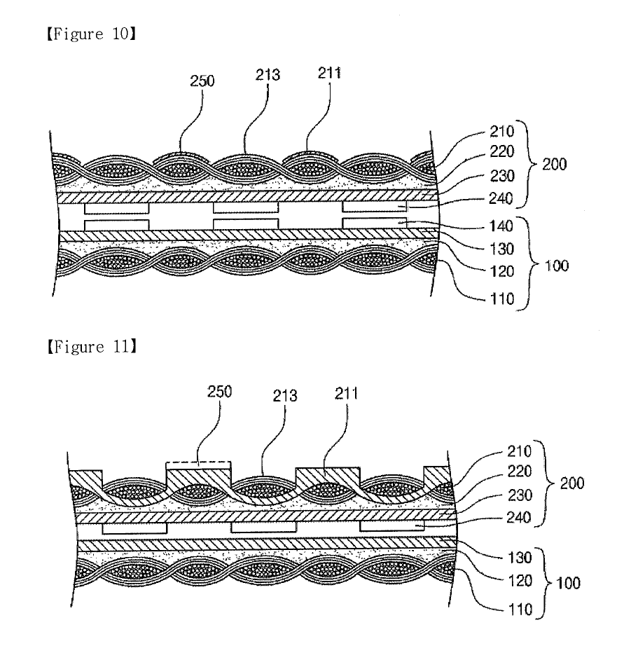

FIGS. 11 to 13 are cross-sectional views of a double-layered fabric having uneven surface topology according to another embodiment of the present invention and the basic structure thereof is the same as the embodiments shown in FIGS. 2 to 4. In the present embodiment, the surface of the base layer 210 has an uneven surface topology.

That is, the base layer 210 of the surface layer may have uneven surface. This uneven surface may be formed by adopting various weaving and knitting methods. The protrusion portion 211 and concave portion 213 can be designed according to a predetermined pattern. FIGS. 2 and 3 show the protrusion portion 211 and concave portion 213 having a predetermined distance. The printing layer 250 including number or sign may be further formed on the protrusion portion 211. The printing layer 250 can be formed by various techniques, such as transfer printing, dyeing, and so forth.

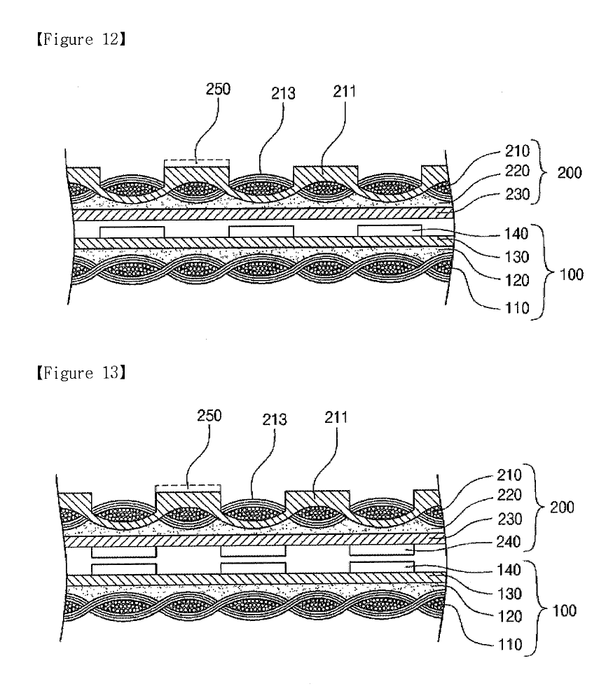

FIG. 14 is cross-sectional views of a triple-layered fabric according to another embodiment of the present invention.

The electronic fabric according to the present invention may be formed in a triple-layered structure comprising the backing layer 100, the surface layer 200, and a pad layer 300.

The backing layer 100 and the surface layer 200 may be formed in the same manner as described in FIGS. 2 and 4.

In accordance with the electronic fabric of the present invention, the pad layer 300 is additionally formed on the surface layer 200. The printing layer 310 is additionally formed on the pad layer 300. To improve effect, the printing layer may have uneven surface structure. The uneven surface should not have the insulating layer in the surface layer and the backing layer, which formed under the protrusion portion 311 like the embodiment as shown in FIGS. 11 to 13. The generation and recognition principles of electronic signals are the same as described in FIGS. 2 and 4.

FIG. 15 is cross-sectional views of a triple-layered fabric according to another embodiment of the present invention. A filling member 400 may be further formed between the surface layer 200 and the pad layer 300. The filling member 400 gives the pad layer 300 a three-dimensional effect and performs a function as distinguished sign on a surface of the pad layer.

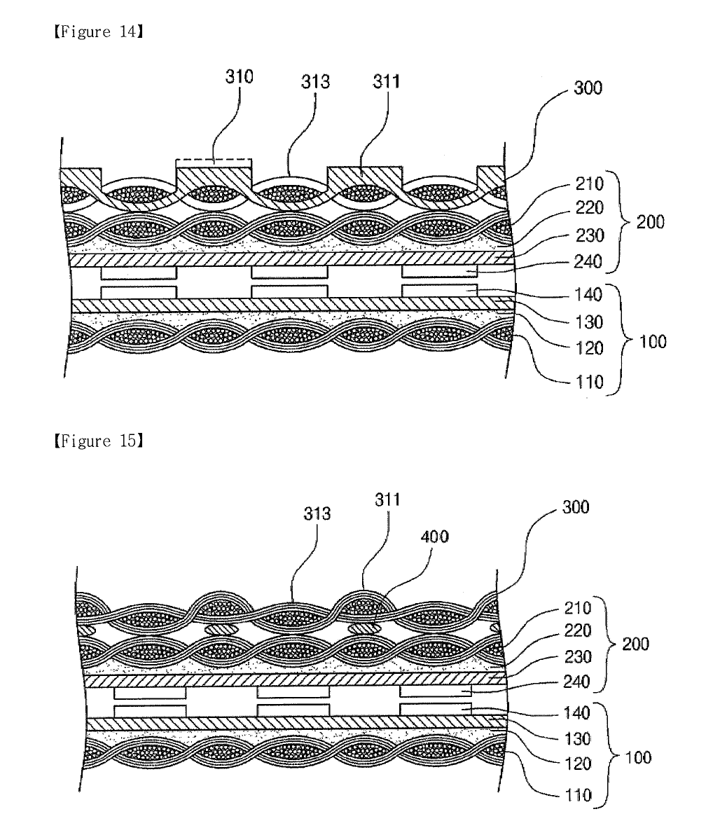

FIG. 16 is a cross-sectional view of a double-layered fabric according to another embodiment of the present invention. The formation principle is the same as the above-mentioned embodiments. There is a difference that the insulating layer 140 may perform a function as an insulating sheet regardless of the conductive layer 130.

Hereinafter, methods for fabricating electronic fabrics according to preferred embodiments of the present invention will be provided in more detail.

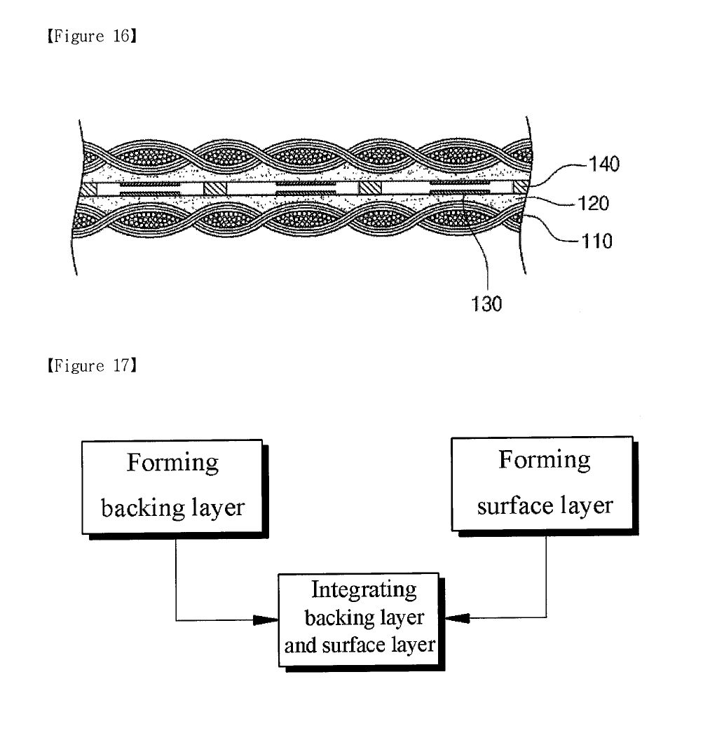

FIG. 17 is a process flowchart for illustrating a method for preparing a double-layered electronic fabric shown in FIG. 2 according to a preferred embodiment of the present invention.

With reference to FIG. 17, the method for preparing the electronic fabric according to the present invention comprises forming the backing layer S100, forming the surface layer S200, and integrating the backing layer and the surface layer S300.

Forming the backing layer S100 includes calendering S110, forming the primer layer S120, forming the conductive layer S130, and forming the insulating layer S140.

A woven or knitted textile as a material for a base layer 110 is introduced between two pressing rollers to compensate surface irregularities of the textile. This calendering is performed to make the surface of the base layer 100 smooth, offset pores of the base layer 110 and enhance the flex resistance of the heating fabric. This calendering is optional depending on the characteristics of the fabric of the base layer 110 (S110).

A primer layer 120 is formed on the base layer 110, undergone calendering, to achieve more active control of the surface pores of the base layer 110 and uniform thickness of the conductive layer 130 to be formed thereon. The primer layer 120 may be formed by knife rolling, over roll coating, floating knife coating, knife over roll coating, laminating, printing or gravure printing (S120).

After forming the primer layer 120, the conductive layer 130 is formed on the primer layer 200 or the base layer 100. The conductive layer130 are previously designed. The conductive layer 130 can be formed by various techniques, such as coating, printing and transfer printing. In a particular embodiment of the present invention, the conductive layer 130 are formed by printing. In this case, a circuit can be designed in fabrics according to the pre-designed pattern, regardless of the placement of electronic devices.

In view of the foregoing, the heating fabric of the present invention can be termed a ⊚lexible printed fabric circuit board (FPFCB)⊚

Patterns of printed fabric circuit depend on the length and width of conducting line. FIG. 7 shows a circuit pattern according to an embodiment of the present invention. Reference numerals 130 and 130 designate the conductive layer, and numeral reference 410 designates bent portions of the circuit. Preferably, the bent portions of the circuit are curved portions.

The reason can be supported by the following equations:

W=I²R

R=r×L/S

(W: power, R: resistance, r: specific resistance, L: length of conducting line, and S: cross-sectional area).

As the cross-sectional area increases, the resistance decreases and the flow of electricity increases. Accordingly, the bent portions are formed in curved portions, thereby flowing a larger amount of current. A surge refers to a transient waveform of electric current, voltage or power that abruptly increases within a short time and gradually decreases during flow along an electric wire or circuit. A surge is mainly responsible for electricity interruption, telephone disconnection and damage to sensitive semiconductors when lightning flashes. Since sudden over-voltage, particularly strong or long surge in a power line may cause dielectric breakdown or disorder of electronic devices, a surge protector or inhibitor is installed between a power supply terminal and a computer terminal to inhibit or minimize a change in electric current.

Thus, the area of the bent portions is reduced to minimize the occurrence of surge and allow the electricity to smoothly flow through the conductive layer despite an increase in the amount of current.

The conductive layer 130 has a thickness of 2 mm to 500 mm and a width of 10 mm to 20 mm. The conductive layer 300 may be composed of 1-30% by weight of carbon and 1-70% by weight of silver. A binder that can be used to form the conductive layer is selected from the group consisting of polyurethane resins, acrylic resins, silicone resins, melamine resins, epoxy resins, which are compatible with the primer layer 200 (S130).

After the conductive layer 130, the insulating layer 140 may be formed thereon, or on an upper region of the base layer or primer layer where the conductive layer 130 is not formed. The insulating layer 140 may be formed by coating, printing or laminating at least one selected from the group consisting of polyurethane, acrylic, silicone, polyester, polyvinyl chloride (PVC) and polytetrafluoroethylene (PTFE) resins on the conductive layer. Dry coating, hot-melt dot lamination or gravure printing is preferably employed to form the insulating layer 500.

As aforementioned, the insulating layer 140 is not formed at a region in which the protrusion portion 211 of the uneven surface structure is not formed (S140).

Meanwhile, the surface layer 200 may include the primer layer 220, the conductive layer 230, and the insulating layer 240 may be formed on a pre-designed uneven surface of the base layer 210.

The prepared surface layer and the backing layer may be bonded by sewing, adhesion, cross-linking, and so forth.

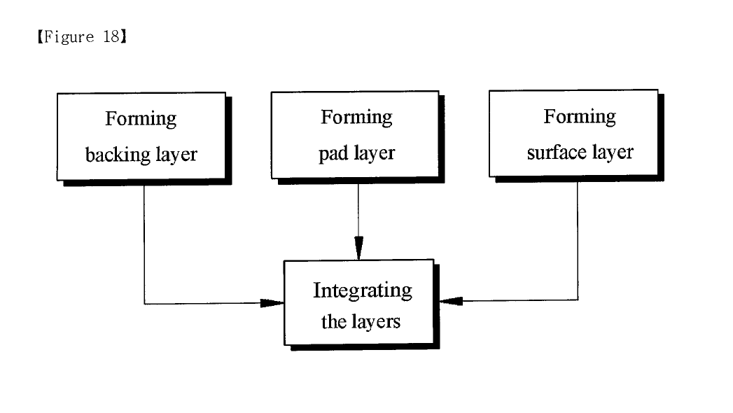

In the embodiment of FIG. 16, the backing layer and the surface layer are formed, and the pad layer may be bonded therewith in the above-mentioned manner (See FIG. 18).

Although the present invention has been described herein with reference to the foregoing embodiments and the accompanying drawings, the scope of the present invention is defined by the claims that follow. Accordingly, those skilled in the art will appreciate that various substitutions, modifications and changes are possible, without departing from the spirit of the present invention as disclosed in the accompanying claims. It is to be understood that such substitutions, modifications and changes are within the scope of the present invention.

Particularly, although the electronic fabric according to the present invention only has been described in the field of keyboard apparatus among smart clothes throughout the specification, it will of course appreciated that the present invention is not limited thereto and can be applicable to flexible displays, touch panels, and so forth as well as to circuit substrates or parts of electronic devices in itself.

1. An electronic fabric comprising,
a backing layer configured to have a circuit electrically floated; and
a surface layer configured to electrically connect to the circuit of the backing layer,
wherein the backing layer or the surface layer comprises:
a) a base layer composed of a synthetic, regenerated or natural fiber; and
b) a conductive layer formed on the base layer to be capable of being freely formed by a pre-designed electric pattern,
wherein the base layer and the conductive layer are successively formed to be symmetrically to the backing layer and the surface layer to each other, and
wherein an insulating layer is formed on the backing layer or the surface layer, or a partial upper portion of the conductive layer, or in a region where the conductive layer is not formed.

2. The electronic fabric according to claim 1, further comprising a pad layer on an upper portion of the surface layer.

3. The electronic fabric according to claim 1, wherein a printing layer is further formed on an upper portion of the surface layer or the pad layer,
wherein the printing layer is formed at a region where the insulating layer is not formed.

4. The electronic fabric according to claim 1, wherein the upper portion (an opposite surface of interfaces between the surface layer and the backing layer) of the surface layer has an uneven surface topology.

5. The electronic fabric according to claim 2, wherein the upper portion (an opposite side of interfaces between the surface layer and the pad layer) of the pad layer has an uneven surface topology.

6. The electronic fabric according to claim 4, wherein the insulating layer is formed in a region corresponding to a concave portion of the uneven surface topology.

7. The electronic fabric according to claim 2, wherein a filling member is further included between the pad layer and the surface layer.

8. The electronic fabric according to claim 7, wherein the filling member is formed in a region where the insulating layer is not formed.

9. The electronic fabric according to claim 1, further comprising a primer layer formed on the base layer to make the surface of the base layer uniform.

10-14. (canceled)

15. The electronic fabric according to claim 1, wherein the conductive layer has a thickness of 2 mm to 500 mm.

16. (canceled)

17. A method for fabricating an electronic fabric comprising:
forming a backing layer having a circuit electrically floated;
forming a surface layer electrically connected to the circuit of the backing layer; and
integrating the backing layer and the surface layer,
wherein the backing layer or the surface layer comprises:
a) forming a base layer composed of a synthetic, regenerated or natural fiber;
b) forming a conductive layer formed on the base layer to be capable of being freely formed by a pre-designed electric pattern; and
c) forming an insulating layer is formed on the backing layer or the surface layer, or a partial upper portion of the conductive layer, or in a region where the conductive layer is not formed.

18. The method according to claim 17, further comprising forming a pad layer on the surface layer before integrating the backing layer and the surface layer.

19. The method according to claim 17, further comprising forming a printing layer on of the surface layer or the pad layer,
wherein the printing layer is formed in a region where the insulating layer is not formed.

20. The method according to claim 17, wherein the upper portion (an opposite surface of interfaces between the surface layer and the backing layer) of the surface layer has an uneven surface topology.

21. The method according to claim 18, wherein the upper portion (an opposite surface of interfaces between the surface layer and the pad layer) of the pad layer has an uneven surface topology.

22. The method according to claim 20, wherein the insulating layer is formed in a region corresponding to a concave portion of the uneven surface topology.

23. The method according to claim 18, wherein a filling member is further included between the pad layer and the surface layer.

24. The method according to claim 23, wherein the filling member is formed in a region where the insulating layer is not formed.

25. The method according to claim 17, further comprising forming a primer layer on the base layer to make the surface of the base layer uniform.

26-36. (canceled)

37. An electronic fabric with multi-layered layers, wherein insulating materials are coated in any one layer or corresponding regions to each other, and
wherein conductive materials are exposed at one or more regions that are not coated with the insulating materials in the electronic fabric, and
wherein an opposite side of the region where conductive materials are exposed has an uneven surface topology to dispose a printing layer or a protrusion portion thereon, and
wherein the region coated with conductive materials is not contact with the insulating materials, and if the printing layer or the protrusion portion is sensed, the conductive materials are contact with each other to generate an electronic signal.
